(19) United States
(12) Patent Application Publication
(10) Pub. No.: US 2015/0033669 A1
(43) Pub. Date: Feb. 5, 2015

(54) MULTILAYER FILM WITH ENHANCED INTERLAYER ADHESION

(71) Applicant: Pregis Innovative Packaging, Inc., Deerfield, IL (US)

(72) Inventors: David Vincent Dobreski, Canandaigua, NY (US); Thomas D. Wetsch, St. Charles, IL (US); Jennifer Lawrence, Granville, NY (US); Harrison W. Francett, Queensbury, NY (US)

(73) Assignee: Pregis Innovative Packaging, Inc., Deerfield, IL (US)

(21) Appl. No.: 14/101,104

(22) Filed: Dec. 9, 2013

Related U.S. Application Data
(60) Provisional application No. 61/860,356, filed on Jul. 31, 2013.

(51) Int. Cl. B65D 81/05; B29C 47/06; B65B 7/02

(52) U.S. Cl. CPC B65D 81/052; B65B 7/02; B29C 47/065
USPC 53/403; 428/36.7; 428/523; 428/522; 428/516; 428/476.9; 264/173.19

(57) ABSTRACT

Described herein are multilayer polymeric films with enhanced interlayer adhesion, having a gas barrier layer and a seal layer bonded directly to the gas barrier layer, wherein the seal layer is made of a blended polymer material that may aid in increasing adhesion to the gas barrier layer. Also disclosed are converted multilayer films for use in creating inflatable chambers in fluid communication with other chambers, methods of making the multilayer films, and a method of producing inflatable and sealable films for protective packaging having enhanced performance.

### CROSS-REFERENCE TO RELATED APPLICATIONS

The application claims priority pursuant to 35 U.S.C. §119(e) of U.S. Provisional Application No. 61/860,356 filed Jul. 31, 2013, which is hereby incorporated by reference in its entirety.

### FIELD

The present disclosure relates to the preparation and use of polymer resins and polymer films in multilayer films to enhance interlayer adhesive properties.

### BACKGROUND

Plastic film is useful in the construction of air cushions or air pillows, such as used in protective packaging applications. Air cushions and pillows are generally made from monolayer or multilayer films. Traditional multilayer films have used outer seal layers, a gas barrier layer and a tie layer positioned between the core layer and outer layer. The seal layers function to seal one section of a multilayer film to another section of the same or a second multilayer film. The tie layer acts as an adhesive layer to join the seal and core layer.

Air cushion and air pillow products can, in some cases, be inflated by the end user. For example, the user can inflate the cavity between two plies of a multilayer film, and then seal the cavity to trap the air therein. The advantage of this process is that an un-inflated cushion or pillow product takes up less room than the inflated product, lowering transport costs as well as allowing the end user to control the amount of inflation.

Multilayer films for use in packaging applications have been disclosed including a gas barrier layer of polyamide and/or ethylene vinyl alcohol (EVOH) with outer layers of polyolefin, for example polyethylene. Because these functional layers are made from resins with poor qualities of adhesion to each other (i.e., poor interlayer adhesion), an adhesive layer is positioned between the outer layer and the core layer. Such films with a tie layer between a seal layer and barrier layer are described, for example in U.S. Pat. Nos. 6,982,113; 7,018,495; and 7,223,461. Known adhesive layer resins include chemically modified polyolefins that can bond with both the polyolefin outer layer and the polyamide or EVOH gas barrier layer. Conventional adhesive layers used in these types of applications are maleic anhydride (MAH) grafted polyethylene homopolymers or copolymers.

An improved system of adhering the film layers of materials that otherwise do not adhere or do not adhere strongly is desired.

### SUMMARY

Described herein is a multilayer polymeric film. An embodiment includes a gas barrier layer and a seal layer. The gas barrier layer can be made primarily of a primary barrier layer material that is a first polymer material having elevated impermeability to a gas and has a material property. The seal layer, which is bonded directly to the gas barrier layer, can be made primarily of a primary seal layer material that is a second polymer material of polyethylene. material property of the first and second polymer materials can be incompatible for producing a high-adhesion bonding of the first and second polymer materials during coextrusion. Preferably, the gas barrier or seal layer is made of a blended polymer material comprising a blend of the respective primary material and a third polymer material. The third polymer material can be blended in an amount sufficient to improve the material property of the respective primary material, of the gas barrier or seal layer, so that the seal layer is bondable directly to the barrier layer with high adhesion by coextrusion. In an embodiment, at least one of the primary materials is polyethylene of density lower than that of HDPE.

In an embodiment, the seal layer is of a blended polymer material, and comprises a blend of the second and the third polymer material. In another embodiment, the gas barrier layer comprises a blend of the first and the third polymer material.

In some embodiments, the improved material property is polarity. In general, the first material may be a polar material (having atoms or groups, for example negatively or positively charged groups, attached to the polymer backbone), while the second material is generally non-polar and lacks significant amounts of polar atoms or groups. This difference in polarity generally inhibits interlayer bond adhesion of the first and second polymers by coextrusion. The third material, however, enhances the polarity of the blended material sufficiently to allow bonding of the blended material to the first polymer with high interlayer bond adhesion (e.g., greater than about 1 lb./in or 1.75 N/cm (e.g., T-peel test)). Blended material may comprise polymers with polar groups that can bond covalently or non-covalently with the polymers of the first material. In some embodiments, the seal layer is heat sealable to a seal layer of another film having a similar composition.

In another embodiment, the blended material comprises mostly the second material and the first material is produced from resin comprising a polyamide or an ethylene vinyl alcohol. In another embodiment, the second material is a non-polar polyethylene; and the third material is a polar polyethylene. In another embodiment, the second material is an unmodified polyethylene; and the third material is a modified polyethylene. For example, the second material can be an unmodified polyethylene selected from metallocene linear low density polyethylene (mLLDPE), low density polyethylene (LDPE), linear low density polyethylene (LLDPE), medium density polyethylene (MDPE), or high density polyethylene (HDPE); and the third material can be a polar polymer for example an ionomer, high vinyl acetate content EVA copolymer, or modified polyethylene, for example maleic anhydride modified low density or linear low density polyethylene (mLLDPE, LDPE, LLDPE or HDPE), wherein, if one of the second or third polymer materials comprises HDPE, the other material does not comprise HDPE.

In one embodiment, the multilayer film has another seal layer on an opposite side of the barrier layer. For example, the multilayer film can have a symmetrical arrangement of layers, for example, with the seal layers disposed on opposite exposed, major surfaces of the film. In some embodiments of the multilayer film, the barrier and/or seal layer comprises a plurality of sublayers of similar composition. In many embodiments, the multilayer film has a total thickness, and the barrier layer has a thickness that is 20% or less of the total thickness of the multilayer film. In some embodiments, the multilayer film is a converted film comprising overlaid plies of a multilayer film, having seal layers of each of the plies sealed to each other in a pattern defining inflatable chambers, wherein the pattern may define an inflation region in fluid communication with the chambers, the inflation region configured to receive a nozzle to inflate the chambers.

Also disclosed herein is a method of making the multilayer film, by coextruding the first material and the blended polymer materials. Also disclosed, is a method of producing an inflatable and sealable film for protective packaging, comprising heat sealing overlaid plies of the multilayer film, for instance wherein the seal layers of each of the plies sealed to each other in a pattern defining inflatable chambers connected to an inflation region that received a nozzle to inflate the chambers. In some embodiments, a method of making protective packaging includes injecting air between plies of the multilayer film to inflate the chambers and sealing the inflated chambers to seal the air therein and provide an inflated pillow.

In some cases the converted multilayer film is configured such that when the chambers are inflated and heat sealed to provide air cushions, the air cushions display less than about 3% loss in a creep test over 7 days at 0.1 psi load. In further cases, the multilayer film is configured such that when the chambers are inflated and heat sealed to provide air cushions, the air cushions display less than about 9% loss under vacuum/altitude testing under a pressure of −13 inches of Hg.

### BRIEF DESCRIPTION OF THE DRAWINGS

FIG. 1 is a cross-sectional view of an embodiment of a multilayer film;

FIGS. 2 and 3 are cross-sectional views of embodiments of a multilayer film with seal layers that are each formed by multiple sublayers;

FIG. 4 is a cross-sectional view of an embodiment of a multilayer film with a barrier layer formed by multiple sublayers;

FIG. 5 is a cross-sectional view of an embodiment of a multilayer film in which the barrier and seal layers are each formed by multiple sublayers;

FIG. 6 is a diagrammatic, cutaway view of a coextrusion die for making a seven coextruded-layer film, such as shown in FIGS. 3 and 5;

FIG. 7 is a diagrammatic view of an embodiment of a multilayer film converted for feeding unto an inflatable protective packaging inflation and sealing device;

FIG. 8 is a table describing various embodiments of multilayer films;

FIG. 9 is a table showing an analysis of certain multilayer films of FIG. 7;

FIG. 10 is a table describing various embodiments of multilayer films lacking a tie layer, as well as films comprising a tie-layer positioned between the seal and barrier layers; and

FIG. 11 is a table showing an analysis of the multilayer films of FIG. 10 and a control layer lacking a barrier layer.

### DETAILED DESCRIPTION

The present disclosure is directed to multilayer films, such as for use in protective packaging. In some embodiments, the multilayer films are used in making air cushions or air pillows. In many cases the multilayer films comprise a gas barrier layer and a seal layer, without a tie layer positioned between the gas barrier layer and the seal layer. Multilayer film embodiments lacking a tie layer can display enhanced adhesion properties between the gas barrier layer and the seal layer. The seal layer is mixture of polymer compounds resulting in a resin with superior adhesive properties with respect to the gas barrier layer.

The preferred embodiment of a multilayer film does not require a tie or adhesive layer to be positioned between the gas barrier layer and the seal layer. Rather, the seal layer is configured to adhere directly to the gas barrier layer, because it has characteristics relevant to its adhesion to the barrier layer that have been modified to be more compatible with those characteristics of the gas barrier layer, such as by blending in an adhesion modifier material to provide the seal layer with enhanced adhesion properties for adhering to the material of the barrier layer, for example under conditions encountered during a coextrusion process. The adhesion modifier material can be tie layer material that was previously provided as an independent layer to adhere a seal layer to a barrier layer.

The disclosed multilayer film and methods of making the multilayer film may provide for more efficient and economical production of multilayer barrier films. In many embodiments, the disclosed film may be manufactured using less complex methods and machinery. In many embodiments, the disclosed film may be manufactured using two resins and a three-layer-die co-extruder. Thus, the disclosed film and methods allow for production of films with lower costs. In some cases, the use of fewer layers may allow for films of lower thickness.

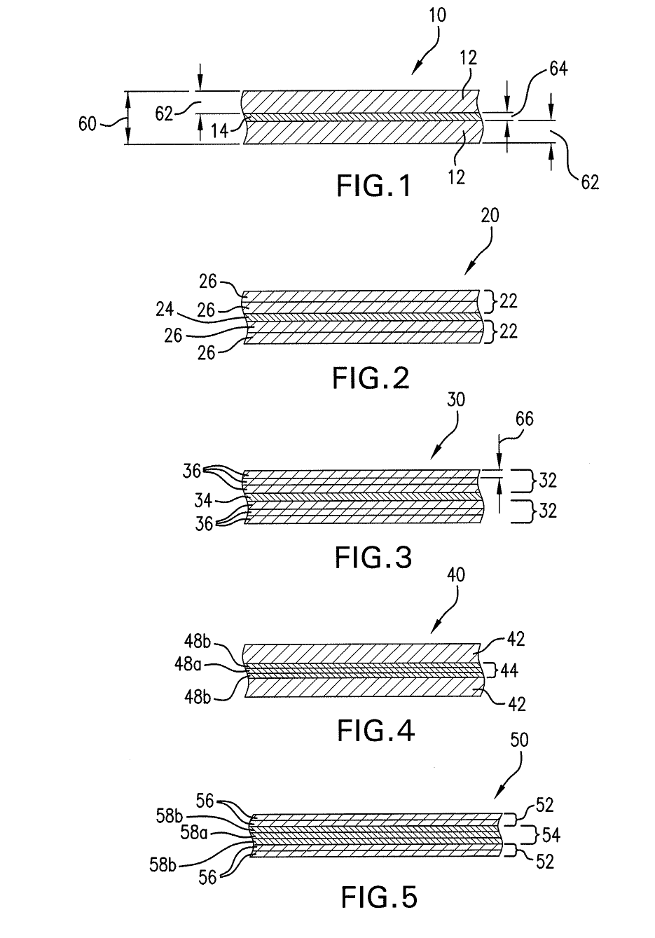

Referring to FIG. 1, seal layers 12 in an embodiment of a multilayer film 10 are positioned as an outer layer of a ply of the film. A barrier layer 14 is disposed between the seal layers 12 as a core of the film ply. This embodiment can be formed with a three-layer-die coextruder, coextruding the seal and barrier layers 12, 14 each as a single co-extruded layer with no sublayers, rendering the layer itself a monolayer.

The disclosed seal layer can be adhered directly to a gas barrier layer without an adhesive layer positioned between the barrier and seal layers. In some embodiments, the seal layer may be a monolayer or the seal layer may comprise two or more sublayers with the same or similar composition of a mixture of unmodified polyethylene and an adhesion modifier that can comprise anhydride modified polyethylene or other suitable adhesion enhancer or tie material. For instance, multilayer film 20 of FIG. 2 has seal layers 22, each of which is formed of two sublayers 26, and multilayer film 30 of FIG. 3 has seal layers 32, each of which is formed of three sublayers 36. The layers and sublayers in the films of FIGS. 1-5 are preferably arranged symmetrically in cross-section about the gas barrier layer of the film. This arrangement of layers helps to keep the film flat, as opposed to bending out of plane or becoming wavy, but it is envisioned that asymmetrical embodiments can alternatively be made. An embodiment has a seal layer on one outer surface and a barrier layer on the other outer surface, and one embodiment has only one seal layer and one barrier layer.

Sublayers that are coextruded together and that are of the same material typically function as a single layer. In many embodiments, each layer or sublayer is typically provided by a single, feed channel in the extruder. The layers and sublayers produced by each feed channel are coextruded from the extruder die to produce the multilayer film, with any sublayers combining to form layers. Thus an embodiment with three layers may be formed using a die having three or more feed channels, with the additional feed channels containing a same or similar polymer as an adjacent feed channel to produce sublayers of one or more layers. In various embodiments, the die coextruder can have an even number or odd number of feed channels. In various embodiments, the number of channels in a die may be 3 or greater, for example 4, 5, 6, 7, or more. In some cases, the number of channels in a die may be significantly greater than the number of layers in the multilayer film.

The barrier layer in the multilayer film preferably is made of materials that have elevated impermeability to air or the fluid that is desired to be contained by the film. In some embodiments, the barrier layer may comprise two or more sublayers with the same or similar composition, and in other embodiments, the barrier layer can include different compositions. For instance, while the films 10, 20, 30 of FIGS. 1-3 each has a single barrier layer 14, 24, 34, with no sublayers, thus providing a monolayer barrier layer; multilayer film 40 of FIG. 4 has barrier layer 44 formed of three sublayers 48a,b. Multilayer film 50 of FIG. 5 has a barrier layer 54 formed of three sublayers 58a,b, and has seal layers 52 each formed of two sublayers 56. Each embodiment shown in FIGS. 1-5 has only three layers, namely, a barrier layer sandwiched between two seal layers. Other embodiments can have additional layers, such as additional inner layers, typically within a pair of barrier layers if the construction is to remain symmetrical.

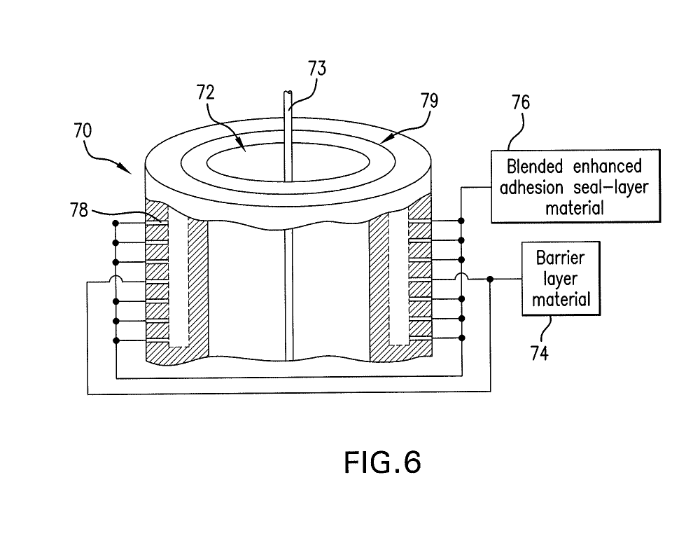

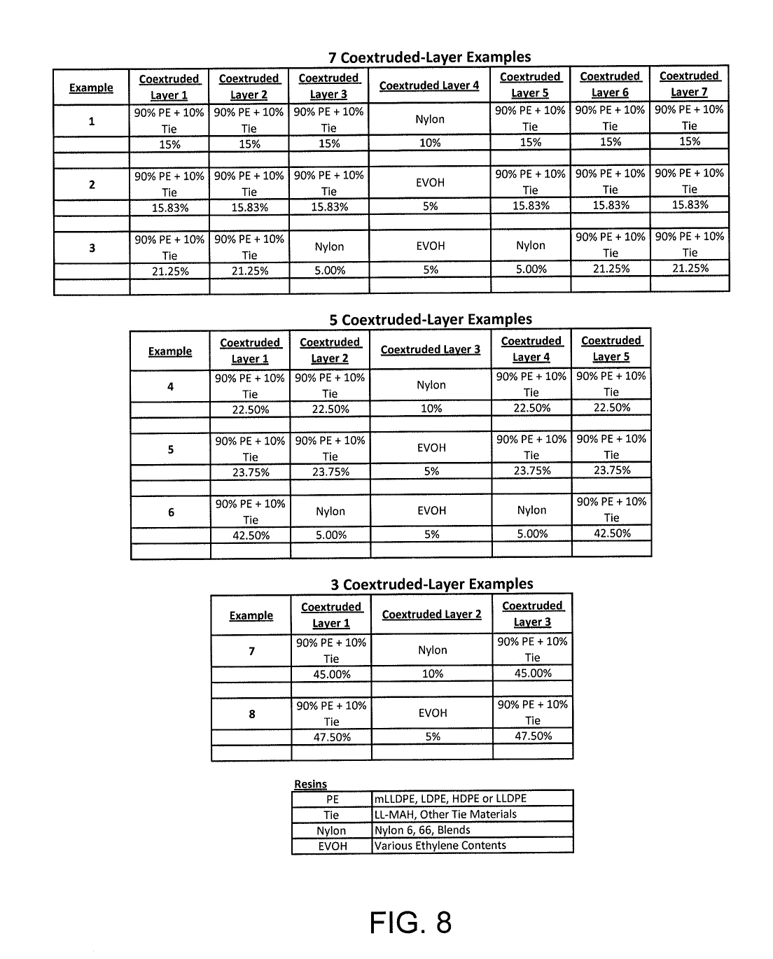

FIG. 6 shows a blown-extruder die 70 for coextruding multilayer-film layers/sublayers, such as the embodiments of FIGS. 3 and 5, and Example 1 of FIG. 8. Typically, air is blown upwards in the drawing into opening 72, and hot air is extracted through tube 73. The material of the barrier and seal layers 74, 76 (or sublayers) is melted and fed through concentric feed channels 78 within the extruder die, the multilayer extrusion exits at die opening 79, and the blown air forms the extruded material into a tubular film, inflated as a bubble by the flow of air into the air column therewithin. The coextruded layers adhere to each other as they solidify due to the enhanced adhesion properties of the seal layer material. Other extrusion or manufacturing processes can be made to form a tube or non-tubular flat sheet of multilayer film material, such as cast film extrusion, which typically uses a flat, linear die opening and forms a sheet of multilayer film material that terminates at two lateral edges.

### Polymers

The disclosed multilayer films include layers made from polymers of differing compositions. In some embodiments, the disclosed layers may be selected from ethylene, amide, or vinyl polymers, copolymers, and combinations thereof.

The disclosed polymers can be polar or non-polar. As used herein, a polar molecule refers to a polymer or molecule on the polymer having an electric charge in some environments. A polar molecule or polymer may interact with other polar molecules by, for example hydrogen bonding. Polarity of a molecule often affects other characteristics, such as melting point. In some embodiments, a polar polymer may have groups with oppositely charged atoms.

The disclosed seal and barrier layer may comprise primary materials. In many cases, the gas barrier layer may be made primarily of a primary barrier layer material that is a first polymer material having elevated impermeability to a gas and has a material property. In many cases, the seal layer is made primarily of a primary seal layer material is a second polymer material of polyethylene, that provides for enhanced sealing to another seal layer and wherein the material property of the first and second polymer materials are incompatible for producing a high-adhesion bonding of the first and second polymer materials during coextrusion. The disclosed ethylene polymer of the seal layer may be a substantially non-polar form of polyethylene. In many cases the ethylene polymer may be a polyolefin made from copolymerization of ethylene and another olefin monomer, for example an alpha-olefin. The ethylene polymer may be selected from low, medium, high density polyethylene, or a combination thereof. In some cases the density of various polyethylenes may vary, but in many cases, the density of low density polyethylene may be for example from about 0.905 or lower to about 0.930 g/cm³, the density of medium density polyethylene may be for example from about 0.930 to about 0.940 g/cm³, and high density polyethylene may be for example about 0.940 to about 0.965 g/cm³ or greater. The ethylene polymer may be selected from linear low-density polyethylene (LLDPE), metallocene linear low density polyethylene (mLLDPE), high density polyethylene (HDPE), medium density polyethylene (MDPE), and low density polyethylene (LDPE).

In some embodiments the polar polymer may be a non-polar polyethylene which may be modified to impart a polar characteristic. In other embodiments the polar polymer is an ionomer (e.g. copolymers of ethylene and meth acrylic acid, E/MAA), a high vinyl acetate content EVA copolymer, or other polymer with polar characteristics. In one embodiment the modified polyethylene may be anhydride modified polyethylene. In some embodiments, the maleic anhydride is grafted onto the olefin polymer or copolymer. Modified polyethylene polymers may react rapidly upon coextruding with polyamide and other ethylene containing polymers (e.g., EVOH). In some cases a layer or sublayer comprising the modified polyethylene may form covalent bonds, hydrogen bonds and/or, dipole-dipole interactions with other layers or sublayers, for example sublayers or layers comprising a barrier layer. In many embodiments, modification of a polyethylene polymer may increase the number of atoms on the polyethylene that are available for bonding, for example modification of polyethylene with maleic anhydride adds acetyl groups to the polyethylene, which may then bond with polar groups of the barrier layer, for example hydrogen atoms on a nylon backbone. Modified polyethylene may also form bonds with other groups on the nylon backbone as well as polar groups of other barrier layers, for example alcohol groups on EVOH. In some embodiments, a modified polyethylene may form chain entanglements and/or van der Waals interactions with an unmodified polyethylene.

Mixtures of ethylene and other molecules may also be used. For example, ethylene vinyl alcohol (EVOH) is a copolymer of ethylene and vinyl alcohol. EVOH has a polar character and can aid in creating a gas barrier. EVOH may be prepared by polymerization of ethylene and vinyl acetate to give the ethylene vinyl acetate (EVA) copolymer followed by hydrolysis. EVOH can be obtained by saponification of an ethylene-vinyl acetate copolymer. The ethylene-vinyl acetate copolymer can be produced by a known polymerization, such as solution polymerization, suspension polymerization, emulsion polymerization and the like, and saponification of ethylene-vinyl acetate copolymer can be also carried out by a known method. Typically, EVA resins are produced via high pressure autoclave and tubular processes.

Polyamide is a high molecular weight polymer having amide linkages along the molecular chain structure. Polyamide is a polar polymer. Nylon polyamides, which are synthetic polyamides, have favorable physical properties of high strength, stiffness, abrasion and chemical resistance, and low permeability to gas, for example oxygen.

Polymers and co-polymers disclosed herein may include various additives. In some cases additives may be added during the extrusion process. In some embodiments, the additives may be colorant, anti-stats, nanoparticles, nanoparticle clay, anti-fog, filler, talc, starch, CaCO₃, slip and/or anti-block. The additives may be incorporated into the resin, or may be incorporated during extrusion. In some embodiments, additives may aid in modifying a barrier layer, for example to decrease oxygen transfer. In some embodiments, additives, for example slip and/or anti-block, may aid in controlling friction and/or adhesion of a film surface. In some cases, slip and/or anti-block may aid in controlling friction and/or adhesion of adjacent film surfaces.

### Barrier Layer

The disclosed multilayer film may include one or more barrier layers that create a gas barrier. In some embodiments, the barrier layer is made from a resin that is less permeable to a given gas than other layers of the multilayer film. In some cases the gas may be ambient or pressurized air, or a constituent of air, for example, oxygen, nitrogen, carbon dioxide, etc., or a combination thereof. In many embodiments, a gas barrier layer may comprise a polymer selected from, ethylene-vinyl alcohol copolymer, polyamides, other suitable polymer, or a combination thereof. The thickness of the barrier layer may be varied to create an effective barrier to the transmission of a gas through the multilayer film, provide the multilayer film with sufficient strength, provide the multilayer film with sufficient durability, or a combination of these qualities. The use of a polyamide in the barrier layer may help increase the durability of the disclosed multilayer film.

The material of the barrier layer, when selected for its impermeability, can be selected based on its oxygen transfer rate (“OTR”). OTR may be measured by testing procedures well known in the art, for example ASTM D3985. In most cases, the OTR is less than about 100 cc/100 in.²/day. In some embodiments the OTR is less than about 30, 20, or 10. Nylon polymers and copolymers (for example Nylon 6, Nylon 6/6.6, etc.) and/or ethylene vinyl alcohol (EVOH of varying ethylene content, for example 38% ethylene or from about 15%-50% ethylene) can be used as a gas barrier, for example, although alternative embodiments can use other suitable barrier layers.

In some embodiments, the barrier polymer may be blended with polyethylene, for example nylon or EVOH may be blended with polyethylene and/or a polar polymer (e.g. modified polyethylene, ionomer, or high vinyl acetate content EVA copolymer). In some cases, nylon or EVOH is blended with LLDPE and/or modified LLDPE to form the barrier layer. In many embodiments, wherein polyethylene (modified and/or unmodified) is blended into the barrier layer, the amount of polyethylene in the barrier layer is less than about 25%, and preferably less than about 10%. In the preferred embodiments, the thickness of the barrier layer selected to be sufficient to provide the desired air impermeability, and preferably also toughness, tear resistance, and durability to the film.

The barrier layer can have a plurality of sublayers that are of similar or different materials. For instance, several sub-layers of a same material can be co-extruded from adjacent channels in the extruder die. In one embodiment having dissimilar materials forming the barrier sub-layers, the barrier has sublayers of nylon and EVOH, such as with a nylon sublayer sandwiched between EVOH layers, or an EVOH sublayer sandwiched between Nylon layers. As described above, these barrier sublayers may be blended with other polyethylene polymers to create the sublayer. The barrier layer is typically the inner or core layer, and the seal layer is typically the outer layer of the film plies, although an alternative embodiment has a first barrier layer sandwiched between the seal layer and a second barrier layer. In most cases, the multilayer film comprises a barrier layer, or sublayers, that occupy the center channel(s) of a die and may be sandwiched between a similar number of seal layers. For example, a seven layer die extruder may have the barrier layer at layer 4 and seal layers at layers 1-3 and 5-7. In other cases barrier sublayers may be offset, for example barrier layers may be fed into a seven channel die at channel layer 3, while the seal layers are fed into the die at channel layers 1, 2, 4, 5, 6, and 7. In these and some other embodiments the thickness of the seal layers are not symmetrical. That is one seal layer is thicker than the other. In some cases the seal layers on one side of the barrier layer may comprise fewer or more sublayers than the seal layer on the opposite side. In other embodiments, the film may comprise a single barrier layer and a single seal layer, both of which may comprise sublayers.

### Seal Layer

The seal layer is preferably selected to allow the multilayer film to be sealed to another film ply of the same or similar composition. For example, the other ply can be provided by folding the multilayer film over onto itself. The seal layer can be sealed to another similar seal layer by a suitable method, including sonic, heat, or adhesive sealing.

The seal layer in one embodiment is made of or made primarily of a polyethylene resin. In some embodiments, the seal layer is selected from LDPE (low density polyethylene), LLDPE (linear-low density polyethylene), mLLDPE (metallocene linear-low density polyethylene), HDPE (high density polyethylene), or a combination thereof.

The seal layer can be a mixture or blend of modified and unmodified polyethylene. Modified polyethylene can be created by grafting one or more molecules onto the polyethylene to help impart a polar character to the polyethylene. In some embodiments, the molecule is maleic anhydride onto a polyolefin or polyethylene. In some cases the modified polyethylene is modified LDPE or LLDPE. The principal seal layer material typically has poor interlayer adhesion to a barrier layer, that is, the typical seal layer does not adhere well to the barrier layer in an extrusion process. The presently disclosed seal layer is modified to improve its adhesion to the barrier and enhance interlayer adhesion. In an embodiment, the modified polyethylene adheres significantly better to the barrier layer resin than unmodified polyethylene. In some cases the modified polyethylene may be characterized based upon the level of anhydride as high, medium, or low maleic anhydride content resin. Alternative materials can be used, preferably that can be heat sealed to another layer of another ply of film.

The seal layer principal material is preferably modified to enhance a material property, for example its polar character. In many embodiments, a seal layer may be modified such that it is less non-polar. For example, the polar character of a seal layer may be modified such that it is more similar to that of a barrier layer, than to a non-modified seal layer. In many embodiments, the seal layer resin containing modified polyethylene is significantly more polar than the polarity of a seal layer lacking modified polyethylene, which is non-polar. Thus a blended resin will produce a seal layer of polymer chains that have non-polar character (non-modified polyethylene) and polymer chains that have polar character (modified polyethylene). The degree of polarity of a seal layer from a blended resin may be affected by the level of modification (which may be described as high, medium, or low) and/or the relative concentration of modified polyethylene in the blended resin. In many embodiments, a seal layer includes a polyethylene polymer with polar atoms or groups. The level of modification may reflect the number of polar atoms or groups per polymer and/or the type of polar atom or group.

The seal layer in an embodiment is a blend of modified and unmodified polyethylene. In many embodiments the modified polyethylene is modified to increase the number of polar atoms or groups on the polyethylene. In many embodiments, each seal layer 12 of the disclosed multilayer film comprises a mixture of anhydride modified polyethylene and unmodified polyethylene. In some cases, the ratio of modified to unmodified polyethylene is about 0.5-3:9.5-7. In one embodiment the ratio is 1:9. In another embodiment the ratio may be 1:4. Alternative embodiments use other suitable ratios. The amount of modified polyethylene in a seal layer is preferably selected to provide a desired level of adhesiveness to the barrier layer, sealability, and/or durability of the multilayer film. In many cases, adhesiveness of the seal layer is increased by increasing the amount of anhydride modified polyethylene or increasing levels of maleic anhydride in the modified polyethylene.

In some cases the blended resin includes anhydride modified LLDPE and unmodified LLDPE. In some cases the level of anhydride in the modified LLDPE may be high, medium, or low. The percentage or amount of modified polyethylene in the blended resin may be adjusted depending upon the level of anhydride content in the modified polyethylene resin and the desired adhesiveness of the seal layer. In most cases, higher content maleic anhydride content will enhance the adhesiveness of the blended resin layer. In some cases where the modified polyethylene is high content maleic anhydride, the ratio of modified polyethylene to unmodified polyethylene may be low. In cases where the modified polyethylene is low content maleic anhydride, the percentage of modified polyethylene may be higher.

In many cases, wherein the seal layer comprises a blend of modified and unmodified polyethylene, the melting temperature of the blended resin can be more than about 400° F. In some cases, the blended resin can have a melting temperature of about 425° F., or between about 410-440° F. In some cases the melting temperature of the blended resin may be selected to aid in increasing adhesion between the barrier and seal layers. In some cases, the adhesiveness of the blended resin layer may decrease with lower melt temperatures. In some embodiments the melting temperature of a barrier layer resin, such as one containing nylon and/or EVOH, is typically higher than the melting temperature of a seal layer resin, and in some embodiments it may aid in creating the multilayer film to raise the melt temperature of the seal layer. In many cases, a seal layer with a higher melting temperature may require heating the film to a higher temperature to achieve a seal.

### Seal-Barrier Layer Adhesion

The disclosed multilayer film comprises a seal layer in contact with the barrier layer. The composition of the disclosed seal layer is modified to be able to adhere with sufficient strength to the barrier layer having a different composition, without an adhesive layer positioned between the barrier and seal layer. In some cases, the adhesiveness of the seal layer may be controlled, for example by changing the amount of modified polyethylene in the seal layer, for example, by changing the content of maleic anhydride in the modified polyethylene, and/or by changing the melt temperature of the seal layer.

In many cases, the amount of modified polyethylene and unmodified polyethylene blended to provide the polyethylene resin of the seal layer is selected to provide a very high peel force necessary to separate the seal and barrier layers to prevent delamination or ensure that it rarely occurs. In some embodiments, the interlayer adhesion is sufficiently high that a peel force cannot be accurately measured. In most embodiments, the adhesion bonding between the barrier layer and seal layer may be measured such as by a standard 180° peel strength test, in which a layer is pulled back over itself. In most embodiments, the peel strength of the presently claimed multilayer material is greater than about 200 grams force. In some embodiments the interlayer adhesion is a high-adhesion bonding to render a peel strength of greater than about 400 grams force measured by standard, ASTM, 180° peel strength testing. In some cases the peel strength may be expressed in lb./in. or N/cm, and the peel strength of the presently claimed multilayer material is greater than about 0.5 or 1.0 lb./in, or about 0.9 or 1.75 N/cm, such as measured in a T-peel test (e.g., ASTM D1876). In preferable cases the T-peel strength of the claimed multilayer film is above 2 or 2.5 N/cm, and in some cases the peel strength (e.g., T-peel or 180° peel is higher than the tensile strength of one or both layers so that the layers themselves break before they peel from each other. In such blended resins comprising modified and unmodified polyethylene, the two polyethylenes may entangle and/or bond via van der Waals interactions during extrusion. The modified and unmodified polyethylene can be provided as a mixture of solid pellets particulates, such as regrind, pellets, or other particulates into the extruder.

The seal layer can be extruded as a plurality of sublayers having the same or similar composition. Multiple adjacent extrusion die channels can be used to co-extrude the multiple sublayers that bond to form the single seal layer. Such co-extrusion can be performed to result in a seal layer that has similar characteristics and behaves as does a mono-layer seal layer that is extruded through a single layer die.

Bonding between seal layer and barrier layers may be via covalent or non-covalent bonds depending on the materials used. In some cases, non-covalent bonding may include hydrogen bonding, ionic bonding, electrostatic bonding, van der Waals bonding, and hydrophobic interactions. In some cases, for example where the seal layer comprises anhydride modified polyethylene and is positioned next to a barrier layer of EVOH or polyamide, anhydride groups of the modified anhydride covalently bond to hydroxyl groups of the barrier layer, and hydrogen bonding occurs between the anhydride groups and the amide or hydroxyl groups of the barrier layer.

### Thickness

Typical multilayer films have a thickness of about 0.5-2 mil, more typically about 0.75-1.25 mil, and typical films have an overall thickness of about 1 mil. Typically, the thickness of an individual layer is between about 1% and 99% of the total thickness of the multilayer film. Typically the barrier layer may be between about 1% and 20% of the total thickness of the multilayer film, and typically the seal layers may be between about 99% and 50% of the total thickness of the multilayer film, in many embodiments the seal layer is at least 70%, but more preferably at least 80%, with each individual seal layer being between about 49.5% and 40%. Other suitable thicknesses can be used in alternative embodiments, as described below.

Typically, the barrier layer thickness 64 is at least about 1% and less than about 20%, while a preferred embodiment may be between about 3% and 17%, in other cases the barrier thickness may be about 5%, 10%, or 15% of the thickness 60 of the multilayer film (while the thicknesses are shown with respect to FIG. 1, they can relate to the other embodiments, as applicable). Some embodiments for use in various types of packaging may benefit from a thicker barrier layer, for example where very low oxygen transfer rates are desired. In another embodiment, the barrier layer is greater than 20%, in some cases up to about 25%, 30%, or more of the multilayer film's total thickness, although other suitable thicknesses can be used in alternative embodiments. In some embodiments, the barrier layer can have a thickness of between about 1% and 7% of the total thickness of the multilayer film. In other cases, the barrier layer may be about 5%, 10%, or 15% of the multilayer film's total thickness. In further embodiments, the barrier layer may be between about 30-1%, 25-5%, or 20-10%, of the multilayer film's total thickness. In most cases, the thickness of the barrier layer is sufficient for the barrier layer to function as a gas barrier. In many embodiments, the thickness of a barrier layer comprising nylon may be more than a barrier layer comprising EVOH, for example between about 3-15% and about 1-10% respectively. In a preferred case, for example where the barrier layer is EVQH, the barrier layer may be about 5% of the multilayer film's total thickness. In another case, for example where the barrier layer is nylon, the barrier layer may be about 10% of the multilayer film's total thickness. In another case, where the barrier layer comprises a core EVOH sublayer positioned between two nylon barrier sublayers, the EVOH sublayer may be about 1-7% of the total thickness of the multilayer film and each nylon sublayer may be about 1-7% of the total thickness of the multilayer film.

In some embodiments, the seal layers can have a thickness of about 80-99% of the total thickness of the multilayer film (while the thicknesses are shown with respect to FIG. 1, they can relate to the other embodiments, as applicable). In some cases, each seal layer may be about 47.5%, 45%, or 42.5% of the multilayer film's total thickness. Where the seal layer comprises two or more sublayers, each sublayers may have the same thickness, for example where the each seal layer is 45% of the total thickness of the multilayer film, and the seal layer comprises three sublayers, each sublayer is 15% of the total thickness of the multilayer film.

As described above, sublayers of a layer may comprise different thicknesses. For example, with reference to FIG. 2, wherein layer 22 comprises two sublayers 26, the two sublayers 26 may have different thicknesses.

### Extrusion

The films of the present invention may be formed by any number of well-known extrusion or coextrusion techniques, although other processes for producing the multilayer film are envisioned. In some cases, the different layers may be extruded at different temperatures to permit melting and extrusion of the material of each layer, with the composition of the seal layer modified to aid in adhering to the material of the barrier layer. In some embodiments, the barrier layer, and often further inner layers, are extruded at temperatures that are higher than the temperature of the seal layer. In some cases, the adhesiveness of the extruded layer may be altered by altering the extrusion temperature.

Suitable coextrusion processes include blown extrusion, in which the composition can be extruded in a molten state through an annular die and then blown and cooled to form a tubular, blown film. In some cases, the blown film tube can be slit and unfolded to form a flat film, and in others it is further converted in its tubular configuration. In a chill roll extrusion processes, for example, each layer resin can be co-extruded through a feedblock and die assembly. For example, the composition can be extruded in a molten state through a flat die and then cooled to form a film.

### Film Conversion and Use

For protective packaging applications, the multilayer film can be converted by heat sealing two plies of the multilayer film to each other in a predetermined pattern and then can be inflated with a fluid, preferably a gas, such as air. In many cases, the inflated films can be sealed by users, for example as disclosed in U.S. Pat. No. 7,862,870, and U.S. patent application Ser. No. 13/844,658. The converted film can be configured for use in a continuous inflation and sealing device, as disclosed in the '658 application or U.S. Pat. Nos. 8,454,779 and 8,061,110, for instance. Devices can be employed that convert, inflate, and seal the plies in-situ, such as disclosed in U.S. Pat. No. 6,789,376. Alternatively, the film can be configured for single inflation operations, and can be provided with check valves between the plies of the multilayer film, for example as disclosed in U.S. Patent Application Publication No. 2004/0163991. In other embodiments, the film can be used in a device for filling the film with foam precursors and sealing the film for foam-in-bag protective packaging, such as disclosed U.S. Patent Application Publication No 2013/0047552.

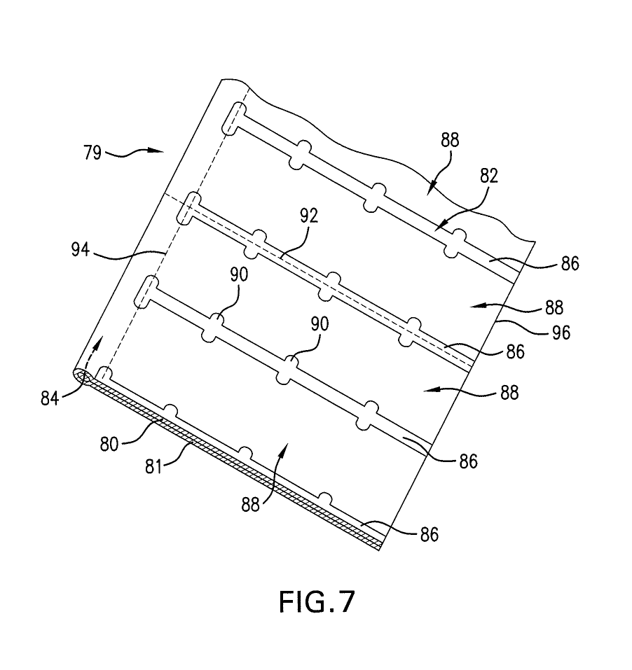

Referring to FIG. 7, during conversion of the film to provide the seal pattern to make protective packaging material 79, the tubular film material can be flattened to provide overlaying plies 80, 81 of the material, or if the material is non-tubular, it can be C-folded, for example, to provide the overlaying plies. A seal pattern 82 is applied to the two plies 80, 81 of film, sealing the contacting seal layers of the plies to each other. In the embodiment shown in the figure, the seal pattern 82 provides an inflation region, which may be a channel 84 to receive an inflation nozzle, and transverse seals 86 to define independent inflatable chambers 88. While channel 84 is closed in a radial direction, except into the chambers 88, to completely surround an elongated nozzle received in the channel 84, alternative embodiments have an open inflation region, for example including two flaps with independent edges opposite from the entries into the chambers 88 to receive a nozzle therebetween in the inflation region. Such flaps can be pinched about the inflation nozzle that blows the gas into the entries of the chambers 88. The edge 96 of the chambers 88 is preferably closed, such as by the fold in a C-fold film or by a longitudinal seal, as would typically be used when two independent plies are laid over each other to form opposite walls of the inflatable protective packaging pillows. Longitudinal seal segments 90 help restrain the height of the chambers 88, once inflated and provide hinge lines in the inflated protective packaging. Weakened lines can also be applied to allow a user to selectively separate from the remaining stock of protective packaging material 79 a length of inflated protective packaging material 79 with a variable number of chambers 88 attached to each other. Such weakened line can be provided, for example, by a line of perforations 92 or other suitable structure. A seal line can be applied such as at line 94, such as by heat sealing or other suitable method, longitudinally across the transverse seal lines to seal the abutting seal layers together to seal the inflated chambers. Other seal segments can be added as known in the art, such as within the chambers, contacting or spaced from the transverse seals 86. Preferred sealing operations involve sufficiently heating the seal layers to stick to each other, such as by melting and cooling at least part of the seal layer. The barrier layer retains a gas, such as air, or other fluid in the inflated chambers. In some embodiments, the fluid may be a foam. The multilayer film can be converted into configurations, and inflated and sealed as disclosed, for example, in the contents of U.S. Pat. Nos. 6,789,376; 7,862,870; 8,061,110; and 8,454,779; U.S. Patent Application Publication No. 2013/0047552; and U.S. patent application Ser. No. 13/844,658.

### EXAMPLES

The disclosure will now be illustrated with working examples, which are intended to illustrate the working of the disclosure and not intended to be taken restrictively to imply limitations on the scope of the present disclosure. The examples below were made with a construction that is summarized in FIG. 8. Other embodiments are also envisioned.

### Example 1

### Seven Coextruded-Layer Film with Polyamide Nylon Barrier Layer (FIG. 3)

A nylon barrier-layer 34 core was positioned between two seal layers 32 of a blended resin comprising polyethylene and anhydride modified polyethylene. The ratio of polyethylene:modified polyethylene was 90:10. In this example, the barrier layer 34 was made as a single coextruded-layer, and each seal layer 32 was formed by coextruding three sublayers of the same composition.

The nylon barrier-layer 34 had a thickness 64 of 10% of the total thickness 60 of the multilayer film 30. Each of the seal-layer sublayers 36 had a thickness 66 of 15% of the total thickness 60 of the multilayer film. Thus, each of the two seal-layers 32 made up 45% of the total thickness 60 of the multilayer film 30.

### Example 2

### Seven Coextruded-Layer Film with Ethylene Vinyl Alcohol Barrier Layer (FIG. 3)

A single-extrusion, EVOH, barrier layer 34 core was positioned between two seal layers 32 of a blended resin comprising polyethylene and anhydride modified polyethylene. The ratio of polyethylene:modified polyethylene was 90:10. In this example, the barrier layer 34 was made as a single coextruded-layer, and each seal layer 32 was formed by coextruding three sublayers of the same composition.

The EVOH barrier-layer 34 had a thickness 64 of 5% of the total thickness 60 multilayer film 30. Each of the seal-layer sublayers 36 had a thickness 66 of 15.83% of the total thickness 60 of the multilayer film. Thus, each of the two seal-layers 32 made up 47.5% of the total thickness 60 of the multilayer film 30.

### Example 3

### Seven Coextruded-Layer Film with Ethylene Vinyl Alcohol and Polyamide Nylon Barrier layer (FIG. 5)

A barrier layer 54 was positioned between two seal layers 52 of a blended resin comprising polyethylene and anhydride modified polyethylene. The ratio of polyethylene:modified polyethylene was 90:10. In this example, the barrier layer 54 was made of a core sublayer 58a of EVQH sandwiched between two sublayers 58b of nylon, and each seal layer 52 was formed by coextruding two sublayers of the same composition.

The EVOH and nylon sublayers 54a,b each had a thickness of 5% of the total thickness 60 multilayer film 50. Each of the seal-layer sublayers 56 had a thickness 66 of 21.25% of the total thickness 60 of the multilayer film. Thus, each of the two seal-layers 52 made up 42.5% of the total thickness 60 of the multilayer film 50.

### Example 4

### Five Coextruded-Layer Film with Polyamide Nylon Barrier Layer (FIG. 2)

A nylon barrier-layer 24 core was positioned between two seal layers 22 of a blended resin comprising polyethylene and anhydride modified polyethylene. The ratio of polyethylene:modified polyethylene was 90:10. In this example, the barrier layer 24 was made as a single coextruded-layer, and each seal layer 22 was formed by coextruding two sublayers of the same composition.

The nylon barrier-layer 24 had a thickness 64 of 10% of the total thickness 60 multilayer film 20. Each of the seal-layer sublayers 26 had a thickness 66 of 22.5% of the total thickness 60 of the multilayer film. Thus, each of the two seal-layers 22 made up 45% of the total thickness 60 of the multilayer film 20.

### Example 5

### Five Coextruded-Layer Film with Ethylene Vinyl Alcohol Barrier Layer (FIG. 2)

An EVOH barrier-layer 24 core was positioned between two seal layers 22 of a blended resin comprising polyethylene and anhydride modified polyethylene. The ratio of polyethylene:modified polyethylene was 90:10. In this example, the barrier layer 24 was made as a single coextruded-layer, and each seal layer 22 was formed by coextruding two sublayers of the same composition.

The EVOH barrier-layer 24 had a thickness 64 of 5% of the total thickness 60 multilayer film 20. Each of the seal-layer sublayers 26 had a thickness 66 of 23.75% of the total thickness 60 of the multilayer film. Thus, each of the two seal-layers 22 made up 47.5% of the total thickness 60 of the multilayer film 20.

### Example 6

### Five Coextruded-Layer Film with Ethylene Vinyl Alcohol and Polyamide Nylon Barrier Layer (FIG. 4)

A barrier layer 44 was positioned between two seal layers 42 of a blended resin comprising polyethylene and anhydride modified polyethylene. The ratio of polyethylene:modified polyethylene was 90:10. In this example, the barrier layer 44 was made of a core sublayer 48a of EVOH sandwiched between two sublayers 48b of nylon, and each seal layer 42 was formed by a single-coextruded layer and had the same composition.

The EVOH and nylon sublayers 44a,b each had a thickness of 5% of the total thickness 60 multilayer film 40. Each of the two seal-layers 42 made up 42.5% of the total thickness 60 of the multilayer film 40.

### Example 7

### Three Coextruded-Layer Film with Polyamide Nylon Barrier Layer (FIG. 1)

A nylon barrier-layer 14 core was positioned between two seal layers 12 of a blended resin comprising polyethylene and anhydride modified polyethylene. The ratio of polyethylene:modified polyethylene was 90:10. In this example, each of the barrier layer 14 and seal layers 12 was made as a single coextruded-layer, and the two seal layers 12 had the same composition.

The nylon barrier-layer 14 had a thickness 64 of 10% of the total thickness 60 multilayer film 10. Each of the two seal-layers 42 made up 45% of the total thickness 60 of the multilayer film 10.

### Example 8

### Three Coextruded-Layer Film with Ethylene Vinyl Alcohol Barrier Layer (FIG. 1)

A EVOH barrier-layer 14 core was positioned between two seal layers 12 of a blended resin comprising polyethylene and anhydride modified polyethylene. The ratio of polyethylene:modified polyethylene was 90:10. In this example, each of the barrier layer 14 and seal layers 12 was made as a single coextruded-layer, and the two seal layers 12 had the same composition.

The EVOH barrier-layer 14 had a thickness 64 of 5% of the total thickness 60 multilayer film 10. Each of the two seal-layers 42 made up 47.5% of the total thickness 60 of the multilayer film 10.

### Example 9

### Testing of Seven Layer Film and Five Layer Film

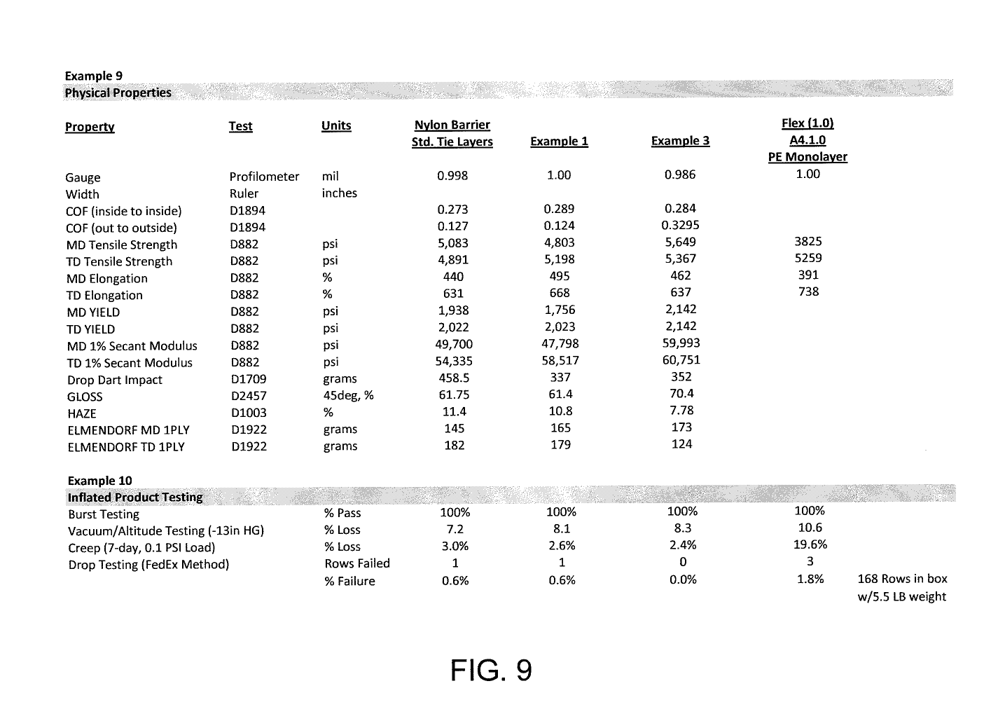

The physical characteristics of the above films of Examples 1 and 3 were examined using standard ASTM tests that are well known in the art. These two films were also used to construct air cushions, which were also tested. The results from these two films were compared to two other films, and are summarized in FIG. 9. These two comparison films were a Nylon containing film with a standard modified polyethylene tie layer (Nylon Std. Tie Layers), and a Flex (1.0) A4.1.0. PE Monolayer film.

The thickness of each film was determined by measuring the gauge of the film using standard measurement protocols for gauge with results given in mils ( 1/1000 of an inch).

The coefficient of friction (COF) for the films was determined using standard ASTM D1894 COF test procedures. The COF was tested in two directions: inside to inside, and outside to outside. The results are shown in FIG. 9.

The tensile strength of the films was determined using the ASTM D882 standard test methods for determining the tensile properties of thin plastic sheeting. Twp orientations were tested, the machine direction (MD) and transverse direction (TD), oriented with respect to the direction in which the films were extruded. This test was used to determine tensile strength, elongation, yield, and the 1% secant modulus. Tensile strength values at break are given in psi. The elongation percentages at break are given as percentages of original sample length. The yield is given in psi. The 1% secant modulus is also given in psi.

The films were also tested for their impact resistance using the standard ASTM D1709 drop dart impact test procedures.

The film gloss was also measured. The percentage of light reflected after striking the film at a 45° angle is given as a percentage in FIG. 9.

The scattering of light by the films, haze, was also measured. In this test, the percentage of light transmitted through the film that is deflected more than 2.5° is given as a percentage.

The tear strength of the films was tested using an Elmendorf test. In this test, the force necessary to propagate a cut in the film is given in grams.

### Example 10

### Air Cushion Testing

The films of Example 9 were used to create air cushions. The inflated air cushions were tested for burst strength, vacuum, creep, and drop testing using standard methods. For example, the drop test was performed according to the standard FedEx method, which is known in the art. Results are summarized in FIG. 9.

### Example 11

### Testing of Seven Layer Films

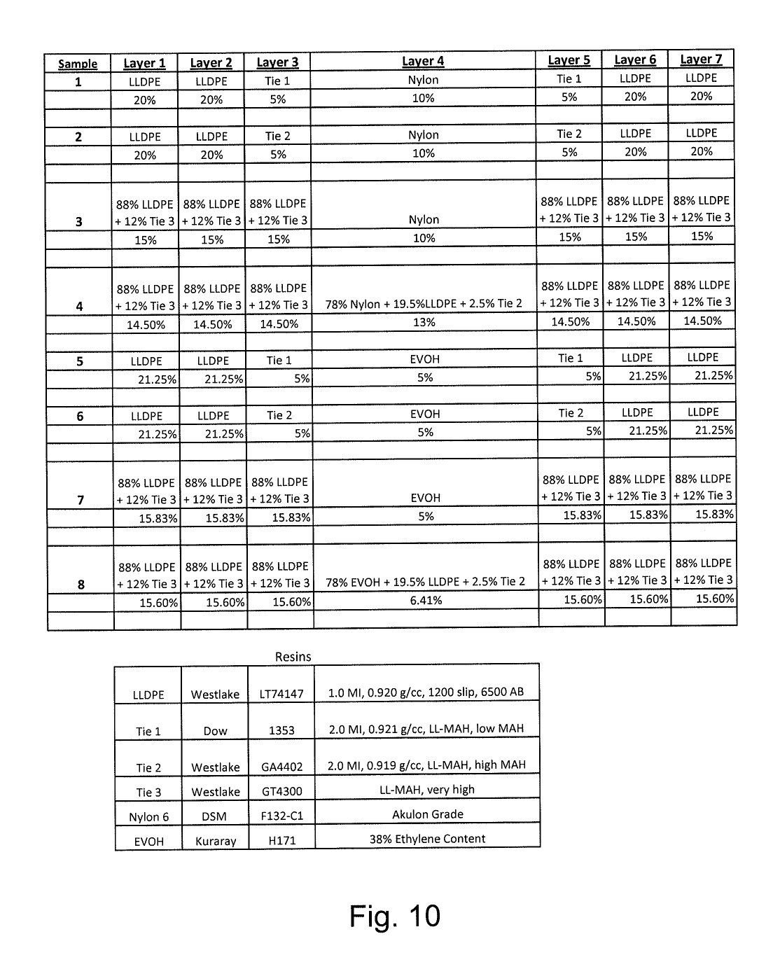

Films made by a seven channel die co-extruder were analyzed. The make-up of the various films is presented in FIG. 10: The films samples were samples 1-8 and a control. The control film lacked a barrier layer. Samples 1-4 comprised a nylon barrier layer and samples 5-8 comprised EVOH in the barrier layer. In FIG. 10 is shown the composition of the various resins used in the tested samples.

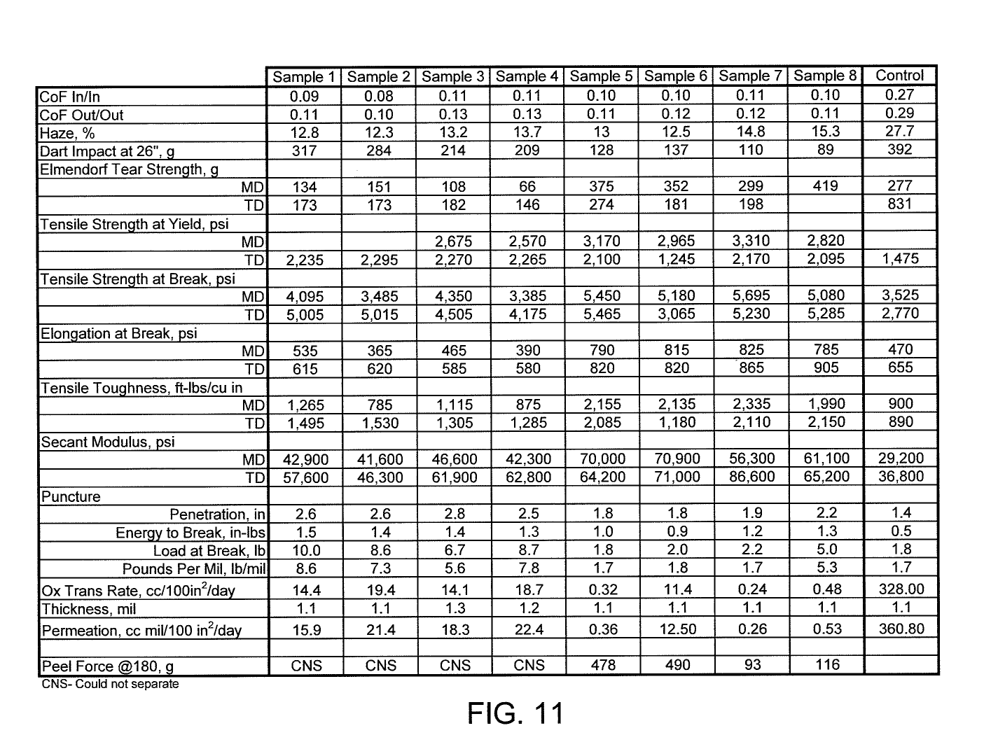

The samples described in FIG. 10 were tested using the methods described previously. In addition, sample films were tested for oxygen transfer rate (Ox Trans Rate or OTR) and peel force (180° peel strength test). The methods used are described above. Results from the tests are presented at FIG. 11. These tests confirmed that the disclosed multilayer film embodiments having blended seal layers (e.g., samples 3-4 and 7-8) had performance characteristics similar to films having a tie layer positioned between the barrier and seal layers (e.g., samples 1-2 and 5-6).

The contents of U.S. Pat. Nos. 6,789,376; 7,862,870; 8,061,110; and 8,454,779; U.S. Patent Application Publication No. 2013/0047552; and U.S. patent application Ser. No. 13/844,658 are incorporated herein by reference. The term “about” and “approximately,” as used herein, should generally be understood to refer to both the corresponding number and a range of numbers. Moreover, all numerical ranges herein should be understood to include each whole integer within the range.

While illustrative embodiments of the invention are disclosed herein, it will be appreciated that numerous modifications and other embodiments may be devised by those skilled in the art. For example, the features for the various embodiments can be used in other embodiments. Therefore, it will be understood that the appended claims are intended to cover all such modifications and embodiments that come within the spirit and scope of the present invention.

What is claimed is:

1. A converted film comprising overlaid plies of the multilayer film, each ply comprising:
a gas barrier layer of a first polymer material; and
a seal layer bonded directly to the gas barrier layer and made of a blended polymer material comprising a blend of;
a second polymer material, wherein the first and second polymer materials are incompatible for producing high-adhesion bonds during coextrusion;
a third polymer material blended with the second polymer in an amount sufficient to improve bonding of the seal layer to the barrier layer; and
wherein the seal layer of each of the plies is sealed to a seal layer of the other ply in a pattern defining inflatable chambers.

2. The converted film of claim 1, wherein:
the second polymer material is high density polyethylene (HDPE), medium density polyethylene (MDPE), metallocene linear low density polyethylene (mLLDPE), low density polyethylene (LDPE), linear low density polyethylene (LLDPE), and mixtures thereof; and
the third polymer material is an ionomer, high vinyl acetate content EVA copolymer, modified high density polyethylene (HDPE), modified medium density polyethylene (MDPE), modified metallocene linear low density polyethylene (mLLDPE), modified low density polyethylene (LDPE), modified linear low density polyethylene (LLDPE), and mixtures thereof, wherein the modification increases the number of polar atoms or groups on the polymer.

3. The converted film of claim 2, wherein:
the second polymer material is linear low density polyethylene (LLDPE); and
the third polymer material is modified linear low density polyethylene (LLDPE) modified to increase the number of polar atoms or groups on the polymer.

4. The converted film of claim 3, wherein the third polymer material is anhydride modified linear low density polyethylene (LLDPE).

5. The converted film of claim 3, wherein the third polymer material is maleic anhydride modified linear low density polyethylene (LLDPE).

6. The converted film of claim 1, wherein the first material is produced from resin comprising a polyamide or an ethylene vinyl alcohol copolymer.

7. The converted film of claim 1, wherein the pattern defines an inflation region in fluid communication with the chambers.

8. A method of making protective packaging material, comprising:
providing the converted film of claim 1;
injecting air between the plies to inflate the chambers; and
sealing the inflated chambers to seal the air therein and provide an inflated cushion.

9. The multilayer film of claim 1, wherein the multilayer film is configured such that when the chambers are inflated and heat sealed to provide air cushions, the air cushions display less than about 3% loss in a creep test over 7 days at a 0.1 psi load.

10. The multilayer film of claim 1, wherein the multilayer film is configured such that when the chambers are inflated and heat sealed to provide air cushions, the air cushions display less than about 9% loss under vacuum/altitude testing under a pressure of −13 inches of Hg.

11. A multilayer polymeric film, comprising:
a gas barrier layer made primarily of a primary barrier layer material that is a first polymer material having elevated impermeability to a gas and has a material property; and
a seal layer bonded directly to the gas barrier layer and made primarily of a primary seal layer material that is a second polymer material of polyethylene, wherein the material property of the first and second polymer materials are incompatible for producing a high-adhesion bonding of the first and second polymer materials during coextrusion
wherein the gas barrier or seal layer is made of a blended polymer material comprising a blend of the respective primary material and a third polymer material, which third polymer material is blended in an amount sufficient to improve the material property of the respective primary material so that the seal layer is bondable directly to the barrier layer with high adhesion by coextrusion; and
wherein at least one of the primary materials is polyethylene of density lower than that of HDPE.

12. The multilayer polymeric film of claim 11, wherein the third polymer material is blended with the second polymer in an amount sufficient to improve the material property of the second polymer material.

13. The multilayer film of claim 12, wherein the third polymer material is selected from an ionomer, high vinyl acetate content EVA copolymer, a modified low density polyethylene (LDPE), modified linear low density polyethylene (LLDPE), modified metallocene linear low density polyethylene (mLLDPE), modified medium density polyethylene (MDPE), modified high density polyethylene (HDPE), and mixtures thereof, wherein the modification increases the number of polar atoms or groups on the polyethylene.

14. The multilayer film of claim 12, wherein the second polymer material is selected from a low density polyethylene (LDPE), linear low density polyethylene (LLDPE), metallocene linear low density polyethylene (mLLDPE), medium density polyethylene (MDPE), high density polyethylene (HDPE), and mixtures thereof.

15. The multilayer film of claim 12, wherein
the second material is selected from metallocene linear low density polyethylene (mLLDPE), linear low density polyethylene (LLDPE), low density polyethylene (LDPE), medium density polyethylene (MDPE), high density polyethylene (HDPE), and mixtures thereof; and
the third material is selected from modified metallocene linear low density polyethylene (mLLDPE), modified linear low density polyethylene (LLDPE), modified low density polyethylene (LDPE), modified medium density polyethylene (MDPE), modified high density polyethylene (HDPE), and mixtures thereof, wherein the modification is an anhydride.

16. The multilayer film of claim 11, wherein the third polymer material is modified low density polyethylene (LDPE), modified linear low density polyethylene (LLDPE), and mixtures thereof wherein the modification increases the number of polar atoms or groups on the polymer.

17. The multilayer film of claim 16, wherein the seal layer is heat sealable to a seal layer of another film having a similar composition.

18. The multilayer film of claim 16, wherein the blended material comprises mostly the second material.

19. The multilayer film of claim 18, wherein the first material is produced from resin comprising a polyamide or an ethylene vinyl alcohol copolymer.

20. The multilayer film of claim 18, wherein:
the second material is linear low density polyethylene (LLDPE); and
the third material is linear low density polyethylene (LLDPE) modified with an anhydride.

21. The multilayer film of claim 18, wherein:
the second material is linear low density polyethylene (LLDPE); and
the third material is metallocene linear low density polyethylene (mLLDPE) modified with an anhydride.

22. The multilayer film of claim 18, wherein:
the second material is unmodified linear low density polyethylene (LLDPE); and
the third material is maleic anhydride modified linear low density polyethylene (LLDPE).

23. The multilayer film of claim 16, wherein the multilayer film has another seal layer on an opposite side of the barrier layer such that the barrier layer is positioned between two seal layers.

24. The multilayer film of claim 23, wherein the multilayer film has a symmetrical arrangement of layers.

25. The multilayer film of claim 24, wherein the seal layers are disposed on exposed surfaces of the film.

26. The multilayer film of claim 11, wherein the barrier or seal layer comprises a plurality of sublayers of similar composition.

27. The multilayer film of claim 11, wherein the multilayer film has a total thickness, and the barrier layer has a thickness of 20% or less of the total thickness of the multilayer film.

28. The multilayer film of claim 11, wherein the third polymer material is blended with the first polymer in an amount sufficient to improve the material property of the first polymer material.

29. The multilayer film of claim 11, wherein the barrier layer comprises two or more sublayers, wherein the sublayers are made up of the same or different first materials comprising one or more of a polyamide, an ethylene vinyl alcohol copolymer, a polyethylene, and a modified polyethylene.

30. A method of producing an inflatable and sealable film for protective packaging, comprising heat sealing overlaid plies of the multilayer film of claim 11, the seal layers of each of the plies sealed to each other in a pattern defining inflatable chambers connected to an inflation region that received a nozzle to inflate the chambers.

31. A converted film comprising overlaid plies of the multilayer film, each ply comprising the multilayer film of claim 11, wherein the seal layer of each of the plies is sealed to a seal layer of the other ply in a pattern defining inflatable chambers.

32. A method of making the multilayer film of claim 11, comprising coextruding the barrier layer and the seal layer into contact with the seal layer, thereby making a multilayer film.

33. A method of making a multilayer film, comprising coextruding:
a barrier layer comprising a first polymer material comprising a polyamide or an ethylene vinyl alcohol copolymer; and
a seal layer comprising a blend of a second material that is low density polyethylene (LDPE) or linear low density polyethylene (LLDPE), and a third material that is modified low density polyethylene (LDPE) or modified linear low density polyethylene (LLDPE);
wherein the barrier layer of the film is coextruded into contact with the seal layer, thereby making a multilayer film.
